(19) United States
(12) Patent Application Publication
(10) Pub. No.: US 2016/0219916 A1
(43) Pub. Date: Aug. 4, 2016

(54) ORAL REHYDRATION COMPOSITIONS WITH GALACTOOLIGOSACCHARIDES

(71) Applicant: ABBOTT LABORATORIES, Abbott Park, IL (US)

(72) Inventor: Steven Luebbers, Columbus, OH (US)

(73) Assignee: Abbott Laboratories, Abbott Park, IL (US)

(21) Appl. No.: 14/915,433

(22) PCT Filed: Aug. 22, 2014
(86) PCT No.: PCT/US2014/052220

§ 371 Date: Feb. 29, 2016

Related U.S. Application Data
(60) Provisional application No. 61/872,172, filed on Aug. 30, 2013.

(51) Int. Cl. A23L 1/054; A61K 31/715; A23K 1/18

(52) U.S. Cl. CPC A23L 1/308; A23L 1/30; A23L 1/304; A23V 2002/00

(57) ABSTRACT

The general inventive concepts are directed to compositions and methods for the prevention and treatment of dehydration. Provided herein are Oral Rehydration Formulas (ORF) having an acidic pH, and comprising a source of carbohydrate, a source of sodium, a source of citrate, and a source of an oligosaccharide.

### TECHNICAL FIELD

The general inventive concepts are directed to compositions and methods for the treatment of dehydration, and more particularly to oral rehydration formulas and uses thereof.

### BACKGROUND

Dehydration resulting from fever, diarrhea, vomiting, or combinations thereof, is a leading cause of morbidity and mortality in the developing world, and while not generally considered a substantial worry for healthy individuals in developed countries, it remains a considerable health concern for those in poor or compromised health. One method for treating dehydration is administration of an Oral Rehydration Formula(s) (ORF). In general, when consumed by an individual afflicted with dehydration, an ORF supplies necessary calories and electrolytes that otherwise the individual would be unable to absorb. This is accomplished through a balance between the amount of carbohydrates and the amount of electrolytes in the ORF. Sodium absorption improves as the dextrose concentration of the oral fluid is increased up to about 2.5% w/w. At higher concentrations, the dextrose can no longer be efficiently absorbed, leading to a net reduction in sodium and water absorption. In fact, higher concentrations of dextrose increase the osmotic load in the gut, which pulls water out of the blood stream. This leads to a net loss of fluids and electrolytes, further exacerbating dehydration.

Only certain carbohydrates are effective in aiding absorption of electrolytes. Generally, simple sugars such as dextrose and fructose are effective while larger carbohydrates do not provide the same benefit. Because of this, an ORF generally does not include oligosaccharides or polysaccharides. Additionally, lactose and lactose containing products are not recommended for consumption by individuals afflicted by diarrhea. Lactose is known to exacerbate the symptoms of diarrhea, and as such, is generally not included in an ORF.

### SUMMARY

The general inventive concepts are directed to oral rehydration formulas, and the use of oral rehydration formulations to prevent or treat dehydration. In certain exemplary embodiments, an oral rehydration formula is provided. The oral rehydration formula comprises a source of carbohydrate in an amount sufficient to provide about 10 mmol/L to about 285 mmol/L of carbohydrate, a source of sodium in an amount sufficient to provide about 10 mEq/L to about 95 mEq/L of sodium, and a source of a galactooligosaccharide in an amount sufficient to provide about 1 to 10 g/L of galactooligosaccharide. Between 50 and 100% of the GOS in the oral rehydration formula is beta-galactooligosaccharide, and the galactooligosaccharide has a degree of polymerization of between 2 and 60. In certain exemplary embodiments, the oral rehydration formula has a pH of about 2 to about 6.5.

In certain exemplary embodiments, a method for the treatment of dehydration is provided. The method comprises preparing an oral rehydration formula, the formula comprising a source of carbohydrate in an amount sufficient to provide about 10 mmol/L to about 285 mmol/L of carbohydrate, a source of sodium in an amount sufficient to provide about 10 mEq/L to about 95 mEq/L of sodium, and asource of a galactooligosaccharide in an amount sufficient to provide about 1 to about 10 g/L of galactooligosaccharide. Between 50 and 100% of the GOS in the oral rehydration formula is beta-galactooligosaccharide, and the galactooligosaccharide has a degree of polymerization of between 2 and 60; and orally administering the oral rehydration formula to an individual.

### DETAILED DESCRIPTION

The general inventive concepts are directed to oral rehydration formulas (ORF), and the use of oral rehydration formulations to prevent or treat dehydration. In certain embodiments, the ORF has an acidic pH, and comprises a source of carbohydrate, a source of sodium, and a source a source of galactooligosaccharide. In certain exemplary embodiments, between 50 and 100% of the galactooligosaccharide in the oral rehydration formula is beta-galactooligosaccharide. In certain exemplary embodiments, the galactooligosaccharide has a degree of polymerization of between 2 and 60.

The term “individual” as used herein, unless otherwise specified, refers to a mammal. In certain exemplary embodiments, the individual is a human, including an infant, a child and an adult.

The term “infant” as used herein, unless otherwise specified, refers to children not more than about one year of age, and includes infants from 0 to about 4 months of age, infants from about 4 to about 8 months of age, infants from about 8 to about 12 months of age, low birth weight infants at less than 2,500 grams at birth, and preterm infants born at less than about 37 weeks gestational age, typically from about 26 weeks to about 34 weeks gestational age. The term “child” or “children” as used herein refers to children not more than 12 years of age, and includes children from about 12 months to about 12 years of age. The term “adult” as used herein refers to adults and children about 12 years of age and older.

One “milliequivalent” (mEq) refers to the number of ions in solution as determined by their concentration in a given volume. This measure is expressed as the number of milliequivalents per liter (mEq/L). Milliequivalents may be converted to milligrams by multiplying mEq by the atomic weight of the mineral and then dividing that number by the valence of the mineral.

The terms “administer,” “administering,” “administered,” or “administration” as used herein, unless otherwise specified, should be understood to include providing the ORF to an individual, the act of consuming the ORF, and combinations thereof. In addition, it should be understood that the methods of administering disclosed herein may be practiced with or without doctor supervision or other medical direction.

The exemplary ORF disclosed herein, and utilized in the exemplary methods, include those suitable for oral administration. Oral administration, as defined herein, includes any form of administration in which the ORF passes through the esophagus of the individual. For example, oral administration includes nasogastric intubation, in which a tube is run through the nose to the stomach of the individual to administer food or drugs.

All percentages, parts and ratios as used herein, are by weight of the total formula, unless otherwise specified. All such weights as they pertain to listed ingredients are based on the active level and, therefore, do not include solvents or by-products that may be included in commercially available materials, unless otherwise specified.

Any reference in the specification or claims to a quantity of an electrolyte should be construed as referring to the final concentration of the electrolyte in the ORF. Tap water often contains residual sodium, chlorine, etc. A value of 15 mEq of sodium in this application means that the total sodium present in the ORF equals 15 mEq, taking into account both added sodium as well as the sodium present in the water used to manufacture the ORF. This holds true for all electrolytes.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The oral rehydration formulas of the present disclosure may also be substantially free of any optional or selected essential ingredient or feature described herein, provided that the remaining formula still contains all of the required ingredients or features as described herein. In this context, and unless otherwise specified, the term “substantially free” means that the selected formula contains less than a functional amount of the optional ingredient, typically less than 0.1% by weight, and also including zero percent by weight of such optional or selected essential ingredient.

In certain exemplary embodiments, the ORF is formulated as a clear liquid having an acidic pH. In certain exemplary embodiments, the ORF has a pH ranging from 2 to 6.5, and also having no more than 0.5% fat by weight of the ORF. The limited amount of fat contributes to the desired clarity and is compatible with a pH of 2 to 6.5 for certain embodiments of the ORF. Typically, the ORF is desired to be clear, or at least substantially translucent, and is substantially free of fat. As used herein “substantially free of fat” refers to an ORF containing less than 0.5%, including less than 0.1%, fat by weight of the total composition. “Substantially free of fat” also may refer to nutritional compositions disclosed herein that contain no fat, i.e., zero fat. In certain exemplary embodiments, the pH of the ORF is about 2.5 to about 4.6. In certain exemplary embodiments, the pH of the ORF is about 3 to about 3.5. In those embodiments of the ORF that are substantially free of fat but have some amount of fat present, the fat may be present as a result of being inherently present in another ingredient, or the fat may be present as a result of being added as one or more separate sources of fat. In certain exemplary embodiments, the term substantially free of fat refers to an ORF wherein there is no caloric lipid component (i.e., less than a functional amount of the ingredient, typically less than 0.5% by weight, and also including zero percent by weight, of such ingredient) in the ORF. In certain exemplary embodiments, an ORF that includes lipid that is introduced as a component of one or more ingredients but does not contribute substantially to the caloric value of the ORF, is considered to be substantially free of fat. In certain exemplary embodiments, an ORF that includes emulsifiers, phospholipids or the like, in amounts that do not contribute substantially to the caloric value of the ORF, is considered to be substantially free of fat.

The ORF and corresponding manufacturing methods disclosed herein can comprise, consist of, or consist essentially of the essential elements and limitations of the disclosure as described herein, as well as any additional or optional ingredients, components, or limitations described herein or otherwise useful in oral rehydration applications.

Oral Rehydration Therapy (ORT) typically involves the administration of an ORF containing, at a minimum, dextrose and sodium in water. An ORF provides rapid, effective hydration because sodium ion absorption in the intestines causes water molecules associated with the sodium ion to also be absorbed. This sodium absorption is activated by dextrose. Specifically, dextrose that crosses the intestinal epithelium brings sodium ions, raising the concentration of sodium ions in the blood stream and pulling water out of the gut.

An ORF can thus be used to correct the fluid and electrolyte losses associated with acute infectious diarrhea or vomiting, or both, to treat hyponatremia or hypohydration due to exercise, changes in altitude, or fever, and to maintain a healthy level of hydration. In fact, the use of ORT has significantly decreased the mortality rate associated with diarrhea, particularly in developing countries.

The general inventive concepts are directed to an ORF comprising sodium, dextrose, and a source of galactooligosaccharide, and the use of the ORF for the prevention of dehydration due to fever and/or other medical conditions not associated with diarrhea and vomiting.

Prebiotics are defined as non-digestible food ingredients that beneficially affect the host by stimulating the growth or activity, or both, of beneficial bacteria in the colon. These bacteria have been shown to provide benefits for digestion and boost immune function. In this regard they may provide benefits to those experiencing dehydration. Oligosaccharides are short to medium chain polymers of sugars, and many have demonstrated prebiotic activity. Examples of oligosaccharides include fructooligosaccharide (FOS), galactooligosaccharide (GOS) and xylooligosaccharide (XOS).

GOS, also known as oligogalactosyllactose, oligogalactose, oligolactose, or transgalactooligosaccharides, is a known prebiotic oligosaccharide. GOS is a polymer of lactose (a disaccharide itself), and most sources of GOS comprise some inherent free lactose. This inherent lactose poses a problem for use of GOS in an ORF. As mentioned previously, lactose is known to exacerbate the symptoms of, for example, diarrhea, and thus ingredients that include lactose are, as a rule, generally not included in ORF.

Inclusion of an oligosaccharide in an ORF is further complicated by the fact that many are unstable in acidic medium, especially when stored for extended (i.e., more than 3 months) periods of time. When subjected to acidic medium, the bonds between the sugars that make up the oligosaccharide are hydrolyzed giving off the individual sugars. In the case of GOS, this hydrolysis would result in free lactose being produced from the oligosaccharide.

In certain exemplary embodiments, the ORF comprises GOS. The GOS used in the ORF described herein may have a variety of degrees of polymerization. In certain exemplary embodiments, the GOS has a degree of polymerization between 2 and 60. In certain exemplary embodiments, the GOS has a degree of polymerization between 2 and 40. In certain exemplary embodiments, the GOS has a degree of polymerization of between 2 and 20. In certain embodiments, the GOS utilized in the ORF is beta-galactooligosaccharide (beta-GOS). The beta-GOS comprises beta 1,4 and beta 1,6 linkages. In certain embodiments, the beta-GOS comprises a majority of beta 1,4 and beta 1,6 linkages based on total linkages linking the monomeric carbohydrate units. In certain exemplary embodiments, the beta-GOS comprises between 60 and 100% beta 1,4 and beta 1,6 linkages based on total linkages linking the monomeric carbohydrate units. In certain exemplary embodiments, the beta-GOS comprises between 80 and 100% beta 1,4 and beta 1,6 linkages based on total linkages linking the monomeric carbohydrate units. In certain exemplary embodiments, the beta-GOS comprises between 90 and 100% beta 1,4 and beta 1,6 linkages based on total linkages linking the monomeric carbohydrate units.

The quantity of beta-GOS in the ORF varies widely. In certain exemplary embodiments, a source of beta-GOS is present in the ORF in an amount sufficient to provide between 1 and 10 g/L of beta-GOS. In certain exemplary embodiments, a source of beta-GOS is present in an amount sufficient to provide about 1 g/L to about 5 g/L. In certain exemplary embodiments, a source of beta-GOS is present in an amount sufficient to provide about 1 g/L to about 4 g/L. In certain exemplary embodiments, a source of beta-GOS is present in an amount sufficient to provide about 2.5 g/L to about 3.5 g/L. In certain exemplary embodiments, a source of beta-GOS is present in an amount sufficient to provide about 3 g/L to about 3.2 g/L of the ORF. Beta-GOS is available under the trademark Vivinal™ (Borculo Domo Ingredients, Netherlands).

As previously mentioned, inclusion of lactose is generally avoided in an ORF; however, sources of beta-GOS comprise a certain amount of inherent lactose. In certain exemplary embodiments, the amount of lactose present in the source of beta-GOS varies. In certain exemplary embodiments, the beta-GOS comprises less than about 25% lactose by weight of the source of beta-GOS. In certain exemplary embodiments, the amount of lactose is less than about 15% by weight of the source of beta-GOS. In certain exemplary embodiments, the amount of lactose is less than about 10% by weight of the source of beta-GOS.

In certain exemplary embodiments, the ORF comprises dextrose. The quantity of dextrose in the ORF varies widely. In certain exemplary embodiments, a source of dextrose is included in the ORF in an amount from about 1.8 g/L to about 60 g/L. In certain exemplary embodiments, a source of dextrose is present in an amount from about 4.5 g/L to about 60 g/L. In certain exemplary embodiments, a source of dextrose is present in an amount from about 5 g/L to about 30 g/L. In certain exemplary embodiments, a source of dextrose is present in an amount from about 10 g/L to about 25 g/L. Alternatively, the amount of dextrose may be expressed as the number of millimoles per liter (mmol/L) of ORF. In certain exemplary embodiments, a source of dextrose is present in an amount from about 10 mmol/L to about 285 mmol/L, including from about 25 mmol/L to about 285 mmol/L. In certain exemplary embodiments, a source of dextrose is present in an amount from about 30 mmol/L to about 180 mmol/L. In certain exemplary embodiments, a source of dextrose is present in an amount from about 50 to about 150 mmol/L.

In certain exemplary embodiments, the ORF further comprise sodium. The sodium in the oral rehydration formulas may be present as a cation of a salt. Examples of suitable sodium sources include sodium chloride, sodium phosphate, sodium citrate, sodium carbonate, sodium bicarbonate, sodium hydroxide, and combinations thereof.

The quantity of sodium ions present in the ORF varies widely. In certain exemplary embodiments, a source of sodium is present in the ORF in an amount sufficient to provide from about 10 mEq/L to about 95 mEq/L. In certain exemplary embodiments, a source of sodium is present in an amount sufficient to provide from about 25 mEq/L to about 95 mEq/L. In certain exemplary embodiments, a source of sodium is present in an amount sufficient to provide from about 30 mEq/L to about 95. In certain exemplary embodiments, a source of sodium is present in an amount sufficient to provide from about 45 mEq/L to about 60 mEq/L of the ORF.

In certain exemplary embodiments, the ORF comprises a particular ratio of moles of dextrose relative to the moles of sodium per liter of the ORF. In certain exemplary embodiments, the molar ratio of dextrose to sodium in the ORF is from about 0.5:1 to about 4:1, including from about 1:1 to about 3:1, including about 2:1.

The ORF of the present disclosure further comprises water. The amount of water present in the ORF will vary. Suitable amounts of water can readily be determined by one skilled in the art, and should be sufficient that, when combined with the other ORF components, will form an ORF having beta-GOS, dextrose, and sodium in the amounts set forth herein.

In certain exemplary embodiments, the ORF further comprise citrate or a source of citrate. The quantity of citrate present in the ORF varies widely. In certain exemplary embodiments, a source of citrate is present in an amount sufficient to provide from about 20 mEq/L to about 200 mEq/L. In certain exemplary embodiments, a source of citrate is present in an amount sufficient to provide from about 30 mEq/L to about 150 mEq/L. In certain exemplary embodiments, a source of citrate is present in an amount sufficient to provide from about 75 mEq/L to about 125 mEq/L. These amounts include citrates from any source, including citric acid; citric ester that can be hydrolyzed into citric acid or a citrate ion; or a citrate salt, such as potassium citrate, sodium citrate, and combinations thereof.

In addition to beta-GOS, dextrose, and sodium, the ORF according to certain exemplary embodiments may contain all the necessary electrolytes and levels thereof required by the Food and Drug Administration for oral rehydration formulations sold in the United States. Further, the ORF may contain a source of carbohydrate in addition to dextrose, such as fructose or sucrose. In certain embodiments, the oral rehydration formulas of this disclosure comprise water, dextrose, zinc, sodium ions, potassium ions, chloride ions, beta-GOS, and citrate ions.

In certain exemplary embodiments, the ORF may contain a source of potassium ions. The potassium in an ORF may be present as an ion in the liquid, and may be in equilibrium with a salt. Examples of potassium salts include potassium chloride, potassium phosphate, potassium citrate, potassium carbonate, potassium bicarbonate, potassium hydroxide, and combinations thereof. The quantity of potassium present in the ORF can vary widely. In certain exemplary embodiments, a source of potassium is present in an amount sufficient to provide from about 5 mEq/L to about 100 mEq/L of potassium. In certain exemplary embodiments, a source of potassium is present in an amount sufficient to provide from about 10 mEq/L to about 50 mEq/L of potassium. In certain exemplary embodiments, a source of potassium is present in an amount sufficient to provide from about 15 mEq/L to about 25 mEq/L of potassium.

In certain exemplary embodiments, the ORF contain a source of chloride. The chloride in an ORF may be present as an ion in the liquid, and may be in equilibrium with a salt. Examples of suitable chloride salts include, but are not limited to sodium chloride, potassium chloride, calcium chloride, magnesium chloride, and combinations thereof. The amount of chloride present in the ORF may vary widely. In certain exemplary embodiments, the ORF will comprise chloride in an amount from about 20 mEq/L to about 50 mEq/L.

In certain exemplary embodiments, the ORF may further comprise a source of zinc. The source of zinc is generally not critical. Any zinc salt suitable for human consumption may be used in the ORF. Examples of suitable zinc sources include zinc gluconate, zinc sulfate, zinc chloride, zinc citrate, zinc bicarbonate, zinc carbonate, zinc hydroxide, zinc lactate, zinc acetate, zinc fluoride, zinc bromide, zinc sulfonate, and combinations thereof. The amount of zinc used in the ORF can vary widely. In certain exemplary embodiments, zinc is present in the ORF in an amount from about 0.1 mEq/L to about 95 mEq/L.

In certain exemplary embodiments, the ORF may also optionally include a source of carbohydrate other than dextrose and beta-GOS. The carbohydrates may be simple and/or complex carbohydrates, including monosaccharides, disaccharides, oligosaccharides, and polysaccharides. Specific examples of suitable carbohydrates include, but are not limited to, dextrose, fructooligosaccharides, fructose and dextrose polymers, corn syrup, high fructose corn syrup, sucrose, maltodextrin, lactose, maltose, amylose, glycogen, galactose, allose, altrose, mannose, gulose, idose, talose, ribose, arabinose, lyxose, ribose, xylose, erythrose, threose, and combinations thereof. Preferably, the carbohydrates are either dextrose alone or dextrose combined with maltodextrin.

In certain exemplary embodiments, the ORF includes one or more additional ingredients. Examples of additional ingredients in an ORF include flavorants, colorants, preservatives, excipients, gelling agents, amino acids, calcium, vitamins, dietary supplements, and combinations thereof. In general, the amount of any additional ingredients in an ORF is such that the primary ingredients remain within the desired ranges.

In certain exemplary embodiments, a flavorant may be present to add or modify a flavor in the ORF, or to enhance its palatability, especially in a pediatric population. Examples of suitable flavorants include anise oil, cinnamon oil, vanilla, vanillin, cocoa, chocolate, menthol, grape, fruit punch flavoring, bubble gum flavoring, peppermint oil, oil of wintergreen, clove oil, bay oil, anise oil, eucalyptus, thyme oil, cedar leaf oil, oil of nutmeg, oil of sage, oil of bitter almonds, cassia oil, citrus oils such as lemon, orange, lime and grapefruit oils, and fruit essences, including apple, pear, peach, berry, wildberry, date, blueberry, kiwi, strawberry, raspberry, cherry, plum, pineapple, and apricot.

In certain exemplary embodiments, artificial sweeteners may also be added to complement the flavor of the ORF. The concentration of sweetener in the ORF may be from about 0.01 to about 0.5 g/L of the ORF. Useful artificial sweeteners include saccharin, nutrasweet, sucralose, aspartame, acesulfame-K (ace-K), and the like.

In certain exemplary embodiments, a colorant may be present to add or modify a color in the ORF. Examples of colorants include FD&C Red No. 3, FD&C Red No. 20, FD&C Yellow No. 6, FD&C Blue No. 2, D&C Green No. 5, FD&C Orange No. 5, D&C Red No. 8, caramel, ferric oxide, pigments, dyes, tints, titanium dioxide, grape skin extract, beet red powder, beta carotene, annato, carmine, turmeric, paprika, and the like.

In certain exemplary embodiments, a preservative may be present to provide a longer shelf life to a pre-packaged ORF, or to extend the potability lifetime of an ORF. Examples of suitable preservatives include, but are not limited to, potassium sorbate and sodium benzoate.

In certain exemplary embodiments, a gelling agent may be present in the ORF, such that the ORF can be formed into a gel, such as a flowable gel or a self-supporting gel. ORF gels may provide improved patient compliance in consuming an ORF, especially in a pediatric population. Gelled rehydration formulas are described in U.S. Pat. No. 6,572,898, hereby incorporated by reference herein. Gelling agents may be included in the ORF in amounts of from about 0.05 to about 50% (w/w).

In certain exemplary embodiments, calcium or a calcium containing substance may also be included in the ORF. Examples of suitable calcium containing substances include calcium chloride, calcium oxide, calcium hydroxide, calcium carbonate, calcium orthophosphate (including mono-, di- and tricalcium phosphate), calcium lactate, calcium gluconate, calcium citrate, calcium acetate, calcium ascorbate, calcium tartarate, calcium malate and mixtures of these. In certain exemplary embodiments, a source of calcium is present in an amount sufficient to provide from about 5 mEq/L to about 30 mEq/L of calcium, including from about 10 mEq/L to about 25 mEq/L, or from about 15 mEq/L to about 20 mEq/L.

The ORF according to certain exemplary embodiments can be manufactured using techniques well known to those skilled in the art. For instance, the ORF may be prepared by combining the non-aqueous (i.e., “dry”) ingredients of the ORF, for example by dry blending, and dispersing the dry ingredients in a suitable amount of water to provide a liquid having the appropriate concentrations of ingredients, as set forth herein. Alternately, one or more of the dry ingredients may be added separately to the water. The ORF may optionally be heated to the appropriate temperature to dissolve all the ingredients, packaged, and sterilized to food grade standards as is known in the art.

The ORF according to certain exemplary embodiments may generally be heat sterilized either by a retort process, an aseptic process, or a hot fill process.

A typical retort process involves introducing the ORF into a metal or plastic container, sealing the container, and then heating the sealed container for a time period and to a temperature sufficient for sterilization. Aseptic sterilization involves separately sterilizing a metal or plastic container and the ORF, and then combining the sterilized container and the ORF in a clean room environment and sealing the container. In a hot fill process, the container is filled with the ORF and sealed at product temperatures above room temperature.

More specifically, in an exemplary retort sterilization method, the ORF is usually preheated and then filled into a clean can, hermetically sealed, and placed in a steam chamber and sterilized, at a temperature of about 100° C., or in certain embodiments about 121° C. for about 15 to about 45 minutes. The batch is then cooled and the retort filled with a new batch. Because sterilization takes place after filling, the need for aseptic handling is eliminated, although heat resistant plastic (or another heat resistant material) must be used due to the high temperatures involved. In one specific retort sterilization embodiment, a hydrostatic tower method is utilized and includes conveying slowly the sealed containers through successive heating and cooling zones in a sterilizer. The zones are dimensioned to correspond to the required temperatures and holding times in the various treatment stages.

In certain exemplary embodiments according to the aseptic sterilization method, the ORF is sterilized and a container is separately sterilized. The ORF may be sterilized utilizing a heating process, for example. The container may be sterilized by spraying the interior wall of the container with hydrogen peroxide and then drying the interior wall. Once the container and the ORF have both been sterilized, the ORF is introduced into the container in a clean room environment and the container sealed.

In certain exemplary embodiments, a hot fill processes alone can be used to sterilize a high acid product (approximately below pH 4.6). In hot fill sterilization, the container is filled with the ORF and the container is sealed at approximately 180° F. The filled container is then rotated end-over-end so that the hot ORF contacts all surfaces and, finally, it is held hot for approximately five to ten minutes to kill all viable microorganisms. Microorganisms which are viable at low pH are molds and yeasts. If the product is a low acid product, approximately above pH 4.6, the hot fill process does not produce adequate sterility. Terminal sterilization is used to kill harmful organisms potentially viable above pH 4.6. Terminal sterilization kills potentially viable organisms by raising product and container temperatures to the equivalent of 250° F. for a time equivalent to at least 3 minutes, more often, in excess of 10 minutes as determined using established practices to calculate sterilization process time as a function of product temperature history. The time the product and container are held at an elevated temperature can be reduced markedly by using sterilizer and product temperatures in excess of 250° F. Sterilizer and product temperatures well in excess of 250° F. are commonly used to reduce sterilization process time.

In certain exemplary embodiments, an ORF may be packaged in a container such as a glass or plastic bottle, a plastic pouch, or a paper-based carton. In certain exemplary embodiments, an ORF may be formed by combining water with the remaining ORF ingredients, agitating and/or heating the mixture to dissolve the ingredients, and then packaging the ORF in a container. The ORF may be sterilized before or after being packaged, such as by retort, aseptic, or hot fill sterilization, as discussed above. The ORF may be packaged in a container that includes an oxygen barrier, an oxygen scavenger, and/or an ultraviolet radiation barrier. A single package of ORF may contain a single serving, such as 12 fl. oz. (0.35 L) or 1 L. A single package of ORF may contain multiple servings, such as multiples of 12 fl. oz. (0.35 L) or of 1 L.

In certain exemplary embodiments, an ORF may also be packaged in non-liquid forms, provided the ORF has undergone heat sterilization. In certain exemplary embodiments, an ORF may be packaged as a gel containing one or more gelling agents as described above. In certain exemplary embodiments, an ORF may be packaged as a frozen solution. Frozen ORF may be in the form of ice cubes, ice on a stick (i.e. “freezer pop”), crushed ice, or shaved ice, for example. Advantageously, frozen ORF may provide improved patient compliance in consuming an ORF, particularly in pediatric populations. Frozen ORF is disclosed, for example, in U.S. Pat. No. 5,869,459, hereby incorporated by reference herein.

In certain exemplary embodiments, the ORF may be used to prevent dehydration in an individual, particularly in individuals suffering from fever. In certain embodiments, an oral rehydration formula is prepared, the formula comprising from about 10 mEq/L to about 95 mEq/L of sodium, from about 10 mmol/L to about 285 mmol/L of dextrose, and at least one source of a galactooligosaccharide in an amount sufficient to provide from about 1 to about 10 g/L of galactooligosaccharide; and orally administering the oral rehydration formula to an individual at risk of developing dehydration.

The total amount of calories provided by the ORF may vary widely. In certain exemplary embodiments, the ORF provides from about 10 kcal/L and 200 kcal/L. In certain exemplary embodiments, the ORF provides from about 30 kcal/L to about 150 kcal/L. In certain exemplary embodiments, the ORF provides from about 50 kcal/L to about 100 kcal/L.

The amount of an ORF administered to the individual will vary. Typically, from about 200 mL to about 4000 mL of the ORF may be administered every 4 to 6 hours, depending on the individual's weight and/or age. Exemplary doses of ORF that may be administered every 4 to 6 hours include: from about 200 mL to about 400 mL for individuals weighing less than about 5.5 kg or who are up to about 6 months old; from about 400 mL to about 900 mL for individuals weighing from about 5.5 kg to about 9.5 kg or who are about 6 to about 12 months old; from about 600 mL to about 1000 mL for individuals weighing from about 9.5 kg to about 13 kg or who are about 12 months to about 3 years old; from about 800 mL to about 1000 mL for individuals weighing from about 13 kg to about 20 kg or who are about 3 years to about 8 years old; from about 1000 mL to about 2000 mL for individuals weighing from about 20 kg to about 40 kg or who are about 8 years old to adult; or from about 2000 mL to about 4000 mL for individuals weighing over about 40 kg or who are adults.

An ORF may be administered in a variety of different forms, depending upon patient preference. For example, some children will consume an ORF more readily if it is frozen, like a freezer pop. The ORF may be administered as a frozen ORF if the patient desires such a choice. Other examples of suitable product forms are set forth herein, such as liquid and gels.

### Examples

The following examples illustrate certain exemplary embodiments or features of the ORF and methods encompassed by the general inventive concepts. The examples are given solely for the purpose of illustration and are not to be construed as limitations of the present disclosure, as many variations thereof are possible without departing from the spirit and scope of the general inventive concepts.

Table 1 is a listing of ingredients for a liquid ORS having an acidic pH and a raspberry fruit flavor, and comprising beta-GOS according to certain exemplary embodiments disclosed herein.

TABLE 1

| Ingredient | Amount per 1000 Kg batch | Kg/g/mg |
|---|---|---|
| Water | Q.S. | |
| Dextrose monohydrate | 18 | Kg |
| Galactooligosaccharides | 6.7 | Kg |
| Citric acid | 2.7 | Kg |
| Potassium citrate | 2.3 | Kg |
| Sodium chloride | 2.1 | Kg |
| Sodium citrate | 1.1 | Kg |
| N&A Punch | 900 | g |
| N&A Raspberry | 900 | g |
| Sucralose | 395.3 | g |
| Acesulfame Potassium | 84 | g |
| Zinc Gluconate | 63.7 | g |
| FD&C Blue 1 | 1.5 | g |
| FD&C Red 40 | 750 | mg |

Table 2 is a listing of ingredients for a liquid ORS having an acidic pH and a cherry fruit flavor, and comprising beta-GOS according to certain exemplary embodiments disclosed herein.

TABLE 2

| Ingredient | Amount per 1000 Kg batch | Kg/g/mg |
|---|---|---|
| Water | Q.S. | |
| Dextrose monohydrate | 18 | Kg |
| Galactooligosaccharides | 6.7 | Kg |
| Citric acid | 2.7 | Kg |
| N&A Punch | 2.5 | Kg |
| Potassium citrate | 2.3 | Kg |
| Sodium chloride | 2.1 | Kg |
| Sodium citrate | 1.1 | Kg |
| Sucralose | 395.3 | g |
| Acesulfame Potassium | 84 | g |
| Zinc Gluconate | 63.7 | g |
| FD&C Red 40 | 16 | g |

A study was performed to determine the stability of GOS relative to FOS (short-chain FOS, scFOS) in an ORF over time (e.g., 1 week, 3 weeks, 6 weeks, and 14 weeks). In a side-by-side test, GOS shows greater stability than scFOS in an aqueous acidic medium. scFOS shows an immediate loss and a time-dependent loss, whereas GOS demonstrates very little change over the period of measurement.

Sample Preparation: A master batch with a pH of 4.25 is sub-divided. The oligosaccharides (GOS and FOS) are added to the respective ORF in an amount of 3.2 g/L. The pH was then adjusted from 4.25 to 3.5 by addition of citric acid. Prior to sterilization, samples are collected to evaluate oligosaccharide levels. The formulas were then delivered into 1 L bottles and subjected to heat sterilization and allowed to cool to room temperature.

Initial Time Analysis: total solids, sodium, potassium, chloride and pH are measured and the results are shown in Table 3.

TABLE 3

| Assay | GOS | FOS |
|---|---|---|
| Total solids | 2.57 | 2.25 |
| pH | 3.47 | 3.44 |
| Chloride mg/kg | 1320 | 1320 |
| Potassium mg/100 g | 119 | 83.4 |
| Sodium mg/100 g | 110 | 111 |

Table 4 shows the results of sample measurements determining the levels of GOS (g/L), galactose (g/L), and lactose (g/L), as determined at 0 days, 3 weeks, 6 weeks, and 14 weeks. The data on day 0 was collected in duplicate for samples prior to sterilization (unsterile) and after sterilization (sterile), thereafter the data was collected only on the sterilized samples. GOS shows very little change over the course of the study with a total loss of 2% determined after 14 weeks.

TABLE 4

| | | Intervals | | | |
|---|---|---|---|---|---|
| Assay | Sample | 0 D | 3 WK | 6 WK | 14 WK |
| GOS | Unsterile 1 | 3.09 | NAP | NAP | NAP |
| g/L | Unsterile 2 | 3.14 | NAP | NAP | NAP |
| | Average | 3.12 | NAP | NAP | NAP |
| | Sterile 1 | 3.08 | 3.08 | 3.13 | 3.14 |
| | Sterile 2 | 3.10 | 3.10 | 3.14 | 3.17 |
| | Average | 3.09 | 3.09 | 3.13 | 3.16 |
| | % Loss (−) or % | −0.8%* | 0%** | 1.2%** | 2.0%** |
| | Increase (+) from 0 D* | | | | |
| Galactose | Unsterile 1 | 0.0670 | NAP | NAP | NAP |
| g/L | Unsterile 2 | 0.0667 | NAP | NAP | NAP |
| | Average | 0.0668 | NAP | NAP | NAP |
| | Sterile 1 | 0.0679 | 0.0679 | 0.067 | 0.0699 |
| | Sterile 2 | 0.0689 | 0.0689 | 0.0661 | 0.0688 |
| | Average | 0.0684 | 0.0684 | 0.0667 | 0.0694 |
| | % Loss (−) or % | 2.3%* | 0%** | 2.4%** | 1.4%** |
| | Increase (+) from 0 D* | | | | |
| Lactose | Unsterile 1 | 0.767 | NAP | NAP | NAP |
| g/L | Unsterile 2 | 0.769 | NAP | NAP | NAP |
| | Average | 0.768 | NAP | NAP | NAP |
| | Sterile 1 | 0.754 | 0.754 | 0.764 | 0.766 |
| | Sterile 2 | 0.764 | 0.764 | 0.760 | 0.754 |
| | Average | 0.759 | 0.759 | 0.762 | 0.760 |
| | % Loss (−) or % | −1.2%* | 0%** | 0.4% | 0.1%** |
| | Increase (+) from 0 D* | | | | |

*% Loss (−) or % Increase (+) at 0 D is calculated comparing the average unsterile to average sterile results at 0 D.
**% Loss (−) or % Increase (+) of 3, 6, and 14 weeks test results and is calculated comparing the average interval results to the average 0 day values.

Table 5 shows the results of sample measurements determining the levels of scFOS (g/L) and % remaining, as determined at 0 days, 3 weeks, 6 weeks, and 14 weeks. The data on day 0 was collected in duplicate for samples prior to sterilization (unsterile) and after sterilization (sterile), thereafter the data was collected only on the sterilized samples. There is a significant drop in level of FOS in the composition immediately following sterilization. After sterilization the level of FOS drops to 11.7% remaining. The amount of FOS then continued to drop during the study period and was undetectable at the last time point for one of the two samples.

TABLE 5

| | | Intervals | | | | | | | |
|---|---|---|---|---|---|---|---|---|---|
| | | 0 D | | 3 WK | | 6 WK | | 14 WK | |
| | | | % | | % | | % | | % |
| Assay | Sample | g/L | Remaining* | g/L | Remaining ** | g/L | Remaining ** | g/L | Remaining ** |
| FOS | Unsterile 1 | 3.25 | 101.6% | NAP | NAP | NAP | NAP | NAP | NAP |
| g/L | Unsterile 2 | 3.25 | 101.2% | NAP | NAP | NAP | NAP | NAP | NAP |
| | Average | 3.24 | 101% | NAP | NAP | NAP | NAP | NAP | NAP |
| | Sterile 1 | 0.374 | 11.70% | 0.3477 | 10.87% | 0.2492 | 7.79% | 0.1265 | 3.95% |
| | Sterile 2 | 0.375 | 11.71% | 0.3471 | 10.85% | 0.2528 | 7.90% | NAP | NAP |
| | Average | 0.375 | 11.70% | 0.3470 | 10.90% | 0.2510 | 7.84% | NAP | NAP |

*% Remaining denotes the % loss (−) or % increase (+) for results calculated comparing the average results for unsterile and sterile samples to the target fortification.
** % Remaining denotes the % loss (−) or % increase (+) of 3, 6, and 14 weeks tests results and is calculated comparing the average interval results to the average 0 day values.

While the general inventive concepts have been illustrated by the description of various exemplary embodiments, and while the exemplary embodiments have been described in considerable detail, it is not the intention of the applicants to restrict or in any way limit the scope of the general inventive concepts or the appended claims to such detail. Additional advantages and modifications will readily appear to those skilled in the art. Therefore, the general inventive concepts are not limited to the specific details, the representative compositions and processes, and illustrative examples shown and described. Accordingly, departures may be made from such details without departing from the spirit or scope of the general inventive concepts.

What is claimed is:

1. An oral rehydration formula comprising:
a source of carbohydrate present in an amount sufficient to provide from about 10 mmol/L to about 285 mmol/L of carbohydrate per liter of oral rehydration formula,
a source of sodium present in an amount sufficient to provide from about 10 mEq/L to about 95 mEq/L of sodium per liter of oral rehydration formula,
a source of galactooligosaccharide (GOS) present in an amount sufficient to provide from about 1 g/L to about 10 g/L of galactooligosaccharide; and
between 50 and 100% of the GOS in the oral rehydration formula is beta-GOS, and the GOS has a degree of polymerization of between 2 and 60.

2. The oral rehydration formula of claim 1, wherein the formula is an aqueous formula with a pH from about 2 to about 6.5.

3. The oral rehydration formula of claim 1, wherein the GOS are present in an amount from about 2.5 g/L to about 3.5 g/L.

4. The oral rehydration formula of claim 1, wherein the carbohydrate is dextrose and is present in an amount from about 30 mmol/L to about 200 mmol/L of oral rehydration formula.

5. The oral rehydration formula of claim 4, wherein the molar ratio of dextrose to sodium is about 0.5: to about 4:1.

6. The oral rehydration of claim 1, wherein the source of GOS comprises less than about 20% lactose.

7. The oral rehydration formula of claim 1, wherein the source of sodium is at least one of sodium chloride, sodium phosphate, sodium citrate, sodium carbonate, sodium bicarbonate, sodium hydroxide, and combinations thereof.

8. The oral rehydration formula of claim 1, further comprising a source of chloride.

9. The oral rehydration formula of claim 8, wherein the source of chloride is at least one of sodium chloride, potassium chloride, calcium chloride, magnesium chloride, and combinations thereof.

10. The oral rehydration formula of claim 1, further comprising a source of zinc.

11. The oral rehydration formula of claim 10, wherein the source of zinc is at least one of zinc gluconate, zinc sulfate, zinc chloride, zinc citrate, zinc bicarbonate, zinc carbonate, zinc hydroxide, zinc lactate, zinc acetate, zinc fluoride, zinc bromide, zinc sulfonate, and combinations thereof.

12. The oral rehydration formula of claim 1, further comprising a source of citrate.

13. The oral rehydration formula of claim 12, wherein the source of citrate is at least one of potassium citrate, sodium citrate, and combinations thereof.

14. A method for the treatment of dehydration comprising:
preparing an oral rehydration formula comprising:
a source of carbohydrate present in an amount sufficient to provide from about 10 mmol/L to about 285 mmol/L of carbohydrate per liter of oral rehydration formula,
a source of sodium present in an amount sufficient to provide from about 10 mEq/L to about 95 mEq/L of sodium per liter of oral rehydration formula,
a source of galactooligosaccharides present in an amount sufficient to provide from about 1 g/L to about 10 g/L of galactooligosaccharide (GOS);
between 50 and 100% of the GOS in the oral rehydration formula is beta-galactooligosaccharide, and the GOS has a degree of polymerization of between 2 and 60; and
administering the oral rehydration formula to an individual at risk of developing dehydration.

15. The method of claim 14, further comprising sterilizing the oral rehydration formula prior to administration thereof.

16. The method of claim 14, wherein the formula is an aqueous formula with a pH from about 2 to about 6.5.

17. The method of claim 14, wherein the beta-GOS has a degree of polymerization from about 2 to about 60.

18. The method of claim 14, wherein the beta-GOS is present in an amount from about 2.5 g/L to about 3.5 g/L.
